(19) United States
(12) Patent Application Publication
(10) Pub. No.: US 2024/0170685 A1
(43) Pub. Date: May 23, 2024

(54) PROCESS FOR PRODUCING A NOBLE METAL-MODIFIED GRAPHITIZED CARBON MATERIAL AND SUPPORTED CATALYST

(71) Applicant: Heraeus Deutschland GmbH & Co. KG, HANAU (DE)

(72) Inventors: Leonard STOICA, Hanau (DE); Robert SIEVI, Hanau (DE); Florian EWEINER, Hanau (DE)

(21) Appl. No.: 18/549,294

(22) PCT Filed: Mar. 1, 2022
(86) PCT No.: PCT/EP2022/055087

§ 371 Date: Sep. 6, 2023

(30) Foreign Application Priority Data
Mar. 11, 2021 (EP) 21161921.8

(51) Int. Cl. H01M 4/88; H01M 4/92

(52) U.S. Cl. CPC H01M 4/8846; H01M 4/8882; H01M 4/926

(57) ABSTRACT

The present invention relates to a process for producing a noble metal-modified, graphitized carbon material, comprising providing a graphitized carbon material, wherein the graphitized carbon material has a degree of graphitization of at least 10%, impregnating the graphitized carbon material with a composition and thermal treatment of the impregnated, graphitized carbon material. The composition comprises an organic solvent and at least one organic noble metal complex dissolved in the organic solvent. The invention further relates to a supported catalyst produced by this process and to an electrochemical cell containing this supported catalyst.

The present invention relates to a process for modifying a graphitized carbon material with noble metal, a supported catalyst produced by the process, and an electrochemical cell containing the supported catalyst.

Noble metal-modified carbon materials are used in a wide variety of technical fields, e.g., exhaust gas cleaning, energy recovery, or in chemical engineering for the synthesis or modification of substances; in particular, they are also used in electrochemical cells—for example, fuel cells and other electrochemical energy converters.

Supported catalysts are generally understood to mean catalysts that contain a support material, the surface of which is modified with a catalytically-active material in a highly dispersed form. Such materials can, for example, be noble metals. Platinum in particular has proven suitable for electrochemical applications. The reactions catalyzed with such supported catalysts are typically surface reactions. Therefore, the available surface area of the catalytically-active species is of crucial importance and should be as large as possible.

The application of a noble metal to carbon materials as a support material is usually done by immersing or impregnating the supports with solutions of salts or complex compounds of the noble metal and subsequent immobilization by precipitation, hydrolysis, heat treatment, calcination, and/or forming. For example, EP3473337A1 describes the modification of carbon supports with metallic platinum, wherein the carbon support is first impregnated with an aqueous solution of a platinum precursor. The impregnated carbon support is subsequently thermally treated, wherein platinum nanoparticles are formed.

Graphitized carbon is a carbon material that, as a result of a thermal treatment of a graphitizable starting material at high temperature, has at least partially a graphite structure; see, for example, H. B. Böhm et al., Pure & Appl. Chem., 67, 1995, pp. 473-506. A high degree of graphitization has proven to be advantageous in particular for electrochemical applications because the corrosion resistance of such a material is increased. For example, EP2352195A1 and JP200526174A describe the advantageous use of such highly graphitized carbon materials as support materials. U.S. Pat. No. 7,687,187B2 explains that an even higher degree of graphitization leads to a stabilization of the carbon support when used as a catalyst in a fuel cell. A “high degree of graphitization” is defined here by a basal plane spacing d002 of less than 0.338 nm.

In principle, the graphitization can take place before and after modifying the porous carbon material with the catalytically-active species. However, graphitization after modification with a noble metal species can lead to an aggregation of the noble metal particles, which in turn can reduce the catalytically-active surface area.

A high degree of graphitization is frequently accompanied by increased hydrophobicity, which limits the possibilities of aqueous impregnation methods. This can prevent a highly dispersed distribution of the catalytically-active, noble metal-containing particles on the support material. The result is a lower catalytic surface area and therefore lower catalytic activity of the catalyst.

It was an object of the present invention to find processes that can be used to produce a noble metal-modified, graphitized carbon material. A further object was the provision of a supported catalyst produced according to the process according to the invention. It was also an object of the invention to provide an electrochemical cell containing said supported catalyst.

The object is achieved by a process for producing a noble metal-modified, graphitized carbon material, comprising the following process steps:
(a) providing a graphitized carbon material, wherein the graphitized carbon material has a degree of graphitization of at least 10%,
(b) impregnating the graphitized carbon material with a composition, wherein the composition comprises
   (i) an organic solvent and
   (ii) at least one organic noble metal complex dissolved in the organic solvent,
(c) thermal treatment of the impregnated, graphitized carbon material.

It has been found that the process according to the invention is particularly suitable for homogeneously modifying the surface of graphitized carbon materials with noble metal. The term, “surface,” includes both the outer and the inner surface, i.e, the inner surface formed by pores is also included. Furthermore, the process according to the invention is particularly suitable for graphitized carbon materials having high hydrophobicity. Due to their low affinity for water in treatment with aqueous solutions, such materials can be problematic because they cannot be completely dispersed, for example, or the aqueous solution does not completely wet any pores present.

The noble metal with which the graphitized carbon material is modified is preferably at least one metal of the platinum metal group, but platinum, palladium, rhodium, and iridium are preferred. Any combination of the noble metals mentioned is also conceivable.

“Modified with a noble metal” means that the noble metal is present on the graphitized carbon material, e.g., in the form of particles or a layer, wherein said layer can be present in a closed or non-closed form.

In process step (a), a graphitized carbon material is provided. The graphitized carbon material has a degree of graphitization of at least 10%.

The graphitized carbon material preferably has a degree of graphitization of at least 15%, and more preferably at least 25%. Particularly preferably, the graphitized carbon material has a degree of graphitization of 10-90%, and very particularly preferably of 15-80%.

Graphitized carbon materials are known to a person skilled in the art and can be prepared by known processes or are commercially available. For example, a carbon material is subjected to a thermal treatment (for example, at a temperature in the range of 1,400° C. to 3,000° C. so that regions having a graphite structure are formed in the carbon material.

The graphitized carbon material is also referred to hereafter as the support material.

As is known to a person skilled in the art and as described, for example, in EP 2954951A1, the graphitization of a carbon material can be determined by means of powder diffractometry. The degree of graphitization g (in %) is determined by means of the following formula (1):

g=[(344 pm−d₀₀₂)/(344 pm−335.4 pm)]×100 (1)

where d₀₀₂ is the graphite basal plane spacing, which is determined using the known Bragg equation on the basis of the diffraction reflexes of the (002) plane in the powder diffractogram of the graphitized carbon material.

In a further embodiment, the graphitized carbon material has, for example, an Lₐ/L_{c} ratio of at least 0.15. The ratio of Lₐ to L_{c} is preferably 0.15 to 3.0, and more preferably 0.15 to 1.5 or 0.15 to 0.5. As will be known to a person skilled in the art, Lₐ and L_{c} are a measure of the average crystallite sizes in the parallel direction (Lₐ) and in the vertical direction (L_{c}) with respect to the basal planes of the graphite structure. As will be described in more detail below, Lₐ and L_{c} are determined by means of powder diffractometry and application of the Scherrer equation. The determination of the Lₐ value is based upon the diffraction reflex of the (100) plane (“100 diffraction reflex”), and the L_{c} value is determined based upon the diffraction reflex of the (002) plane (“002 diffraction reflex”) in the powder diffractogram of the graphitized carbon material.

In a preferred embodiment, the graphitized carbon material is porous. In the context of this invention, pores are understood to mean micropores, mesopores, and macropores.

Micropores have a pore size in the range of less than 2 nm, mesopores have a pore size in the range of 2 to 50 nm, and macropores have a pore size in the range of 50 to 5,000 nm.

Pore size is preferably understood to mean the average size of the pores of the porous material. Accordingly, pore volume is preferably understood to mean the sum of the volumes of such pores.

In a preferred embodiment, the graphitized carbon material has mesopores. Particularly preferably, the maximum of the pore diameter distribution is in the range of the mesopores.

Particularly preferably, the maximum of the pore diameter distribution is in the range of 10 to 200 nm, and preferably in the range of 15 to 150 nm; the maximum can also preferably be in a range of 10 to 100 nm or more preferably in a range of 15 to 75 nm.

The graphitized carbon material preferably has a pore volume of more than 0.1 cm³/g, particularly preferably more than 0.3 cm³/g, and very particularly preferably more than 0.6 cm³/g.

The graphitized carbon material preferably has a pore volume of 0.1 cm³/g to 3.5 cm³/g, more preferably 0.7 cm³/g to 2.5 cm³/g, and particularly preferably 0.9 cm³/g to 1.8 cm³/g.

The porous graphitized carbon material preferably has a BET specific surface area of more than 10 m²/g, more preferably more than 30 m²/g, and particularly preferably more than 40 m²/g.

The graphitized carbon material has, for example, a BET specific surface area in the range of 5 m²/g to 1,000 m²/g, preferably in the range of 10 m²/g to 200 m²/g, and particularly preferably in the range of 20 m²/g to 150 m²/g

The graphitized carbon material is preferably in powder or particulate form.

In a preferred embodiment, the average particle diameter d₅₀ of the graphitized carbon material is in the range of 0.1 μm to 100 μm, preferably in the range of 0.3 μm to 80 μm, and particularly preferably in the range of 0.5 μm to 20 μm. The particle sizes are determined by means of laser diffraction according to ISO standard 13320.

In a preferred embodiment, the d₉₀ value of the particle size distribution of the graphitized carbon material is less than 20 μm, preferably less than 15 μm, and particularly preferably less than 10 μm.

The graphitized carbon material preferably has less than 25 ppm of impurities other than carbon, preferably less than 20 ppm, and particularly preferably less than 18 ppm.

The graphitized carbon material preferably has less than 25 ppm of impurities in the form of iron (Fe), preferably less than 20 ppm, and more preferably less than 15 ppm.

The production of a graphitized carbon material is described, for example, in EP2954951A1. The graphitized, porous carbon material is obtained by first subjecting an organic starting compound to carbonization to obtain a carbonized carbon material and then graphitizing said carbonized carbon material.

Suitable graphitized carbon materials can be obtained by post-graphitizing commercially available materials such as Ketjen Black from Nouryon or are also commercially available, for example, under the name, Porocarb®, from Heraeus.

It may be preferred to subject the support material to a pre-treatment step. Possible pre-treatments include, for example, activation of the graphitized carbon material by plasma treatment or treatment with an acid.

In process step (b), the graphitized carbon material is impregnated with a composition. As a result of step (b), an impregnated support material is obtained.

The composition is preferably liquid and has a low viscosity—for example, a viscosity of less than 100 cP, less than 50 cP, or less than 40 cP at 20° C. and 1,013 hPa. The composition is preferably not a sol-gel. The viscosity of the composition can be determined by means of rotary viscometry using the plate-plate measuring principle with a plate diameter of 25 mm, a measuring gap of 1 mm, and a shear rate of 36 min-1, wherein the viscosity value is determined after a measuring period of 2 minutes.

The composition is preferably a clear solution, i.e., a liquid that is free of colloids or precipitates. The composition preferably comprises only a single phase, i.e., the individual constituents of the composition are mixed completely homogeneously. In other words, the composition is a non-colloidal solution.

When modifying graphitized carbon materials according to the process according to the invention, it is advantageous not to use compositions that contain colloidal noble metal or nanoparticulate noble metal so as to avoid possible risks associated therewith. This is understood to mean the potential toxicity of nanoparticulate heavy metals, such as Pt, Pd, Ir, Rh.

The composition used in step (b) comprises an organic solvent, hereafter also referred to as component A.

In a preferred embodiment, the composition comprises 30% to 90 wt % (% by weight) organic solvent.

In this case, an “organic solvent” means that the solvent comprises at least one liquid substance in which the at least one organic noble metal complex is soluble. The organic solvent accordingly comprises at least one substance that is liquid at 25° C. and 1,013 hPa and in which the at least one organic noble metal complex is soluble. The organic solvent can comprise several chemical substances, i.e., the organic solvent can also be a solvent mixture.

A suitable organic solvent can be selected based upon the solubility of the at least one organic noble metal complex in the organic solvent, compatibility with the desired impregnation process, and/or the required wetting properties with respect to the support material. Preferably, the organic solvent itself should not lead to a change in the support material—for example, due to dissolution or chemical reaction with the support material.

The organic solvent can be selected from a plurality of commercially available organic solvents. The organic solvent is, expediently, substantially volatile under the processing conditions of the composition according to the invention. This applies in particular to the stage after impregnation of a support material with the composition.

In one embodiment, the organic solvent at 1,013 hPa has a boiling point of 30° C. to 250° C., 30° C. to 200° C., or 100° C. to 150° C.

In one embodiment, the organic solvent is a protic solvent. In one embodiment, the organic solvent is an aprotic solvent.

Preferred organic solvents are non-polar substances—for example, uncharged organic compounds. These can be pure hydrocarbons or heteroatom-containing compounds—for example, heteroalkanes, heteroaromatics, and heteroalkenes.

Examples of organic solvents include aliphatics and cycloaliphatics, each having 5 to 12 carbon atoms; halohydrocarbons such as di-, tri-, and tetrachloromethane; aromatics, araliphatics such as toluene or xylene; alcohols such as ethanol, n-propanol, and isopropanol; ethers; glycol ethers such as mono-C1-C4-alkyl glycol ethers and di-C1-C4-alkyl glycol ethers, e.g., ethylene glycol mono-C1-C4-alkyl ether, ethylene glycol di-C1-C4-alkyl ether, diethylene glycol mono-C1-C4-alkyl ether, diethylene glycol di-C1-C4-alkyl ether, propylene glycol mono-C1-C4-alkyl ether, propylene glycol di-C1-C4-alkyl ether, dipropylene glycol mono-C1-C4-alkyl ether, and dipropylene glycol di-C1-C4-alkyl ether; esters having 2 to 12 carbon atoms; and ketones such as acetone, methyl ethyl ketone, methyl isobutyl ketone, and cyclohexanone. Araliphatics such as toluene or xylene, alcohols such as ethanol, n-propanol, and isopropanol, and glycol ethers such as mono-C1-C4-alkyl glycol ethers and di-C1-C4-alkyl glycol ethers, e.g., ethylene glycol mono-C1-C4-alkyl ether, ethylene glycol di-C1-C4-alkyl ether, diethylene glycol mono-C1-C4-alkyl ether, diethylene glycol di-C1-C4-alkyl ether, propylene glycol mono-C1-C4-alkyl ether, propylene glycol di-C1-C4-alkyl ether, dipropylene glycol mono-C1-C4-alkyl ether, and dipropylene glycol di-C1-C4-alkyl ether are preferred.

Particularly preferably, constituent A consists of at least one alcohol—in particular, at least one of the alcohols mentioned by way of example—and/or of at least one glycol ether—in particular, at least one of the glycol ethers mentioned by way of example. Particularly preferred as constituent A are corresponding mixtures of 30 to 70 wt % alcohol and the 100 wt % missing weight fraction of glycol ether.

In one embodiment, the composition comprises a glycol ether.

In one embodiment, the composition comprises a mono-C1-C4-alkyl glycol ether.

In one embodiment, the composition comprises a di-C1-C4-alkyl glycol ether.

In one embodiment, the composition comprises a glycol ether selected from the group consisting of an ethylene glycol mono-C1-C4-alkyl ether, ethylene glycol di-C1-C4-alkyl ether, diethylene glycol mono-C1-C4-alkyl ether, diethylene glycol di-C1-C4-alkyl ether, propylene glycol mono-C1-C4-alkyl ether, propylene glycol di-C1-C4-alkyl ether, dipropylene glycol mono-C1-C4-alkyl ether, and a dipropylene glycol di-C1-C4-alkyl ether.

In one embodiment, the composition comprises a glycol ether and an alcohol.

In one embodiment, the composition comprises a glycol ether and an alcohol in a weight ratio of 1:2 to 2:1. The glycol ether can, for example,
be propylene glycol monopropyl ether. The alcohol can, for example, be ethanol, n-propanol, isopropanol or butanol, or a polyhydric alcohol.

The composition also comprises at least one organic noble metal complex dissolved in the organic solvent, hereafter also referred to as constituent B.

The composition preferably comprises 10 to 70 wt % of the at least one organic noble metal complex.

In one embodiment, the composition comprises 2.5 to 25 wt % noble metal, relative to the total weight of the composition. In one embodiment, the composition comprises 5 to 15 wt %, 8 to 15 wt % or 10 to 15 wt % noble metal, relative to the total weight of the composition.

The at least one organic noble metal complex is preferably a noble metal complex having a diolefin ligand L and C6-C18 monocarboxylate ligands, and preferably selected from the group consisting of noble metal complexes of the type [LPt[O(CO) R1]X]ₙ, [LPd[O(CO)R1]X]ₙ, [LRh[O(CO)R1]]ₘ, and [LIr[O(CO)R1]]ₘ, wherein L is a compound acting as a diolefin ligand, wherein X is selected from bromide, chloride, iodide, and —O(CO) R2, wherein —O(CO) R1 and —O(CO)R2 denote identical or different non-aromatic C6-C18 monocarboxylic acid residues, and wherein n is an integer ≥ 1, and m is an integer ≥ 2.

The term, “compound acting as a diolefin ligand,” as used herein refers to a compound that, in noble metal complexes, provides both or two of its olefinic double bonds with a noble metal central atom in a complexing manner or with two noble metal central atoms in a bridging manner in a complexing manner.

In the case of polynuclear noble metal complexes, the numbers n and m are generally an integer—for example, in the range of 2 to 5. In other words, integer n>1 is generally in the range of 2 to 5; in particular, n is equal to 2, and the noble metal complexes are then binuclear platinum complexes or binuclear palladium complexes. Integer m is also generally in the range of 2 to 5; in particular, m is equal to 2, and the noble metal complexes are then binuclear rhodium complexes or iridium complexes.

The platinum is preferably present in the platinum complexes in the +2 oxidation state.

The palladium is preferably present in the palladium complexes in the +2 oxidation state.

The rhodium is preferably present in the rhodium complexes in the +2 oxidation state.

The iridium is preferably present in the iridium complexes in the +2 oxidation state.

In the embodiment of mononuclear platinum complexes of the type [LPt[O(CO) R1]X], L is a compound acting as a diolefin ligand on the platinum central atom, X denotes bromide, chloride, iodide, or —O(CO)R2; and —O(CO)R1 and —O(CO)R2 denote identical or different non-aromatic C6-C18 monocarboxylic acid residues. In this case, n is equal to 1.

In the embodiment of mononuclear palladium complexes of the type [LPd[O(CO)R1]X], L is a compound acting as a diolefin ligand on the palladium central atom, X denotes bromide, chloride, iodide, or —O(CO)R2; and —O(CO)R1 and —O(CO)R2 denote identical or different non-aromatic C6-C18 monocarboxylic acid residues. In this case, n is equal to 1.

In a preferred embodiment of binuclear or polynuclear palladium complexes of the type [LPd[O(CO)R1]X]n, L denotes a compound acting as a diolefin ligand; X denotes bromide, chloride, iodide, or —O(CO)R2; n denotes 2, 3, 4 or 5, preferably 2; and —O(CO)R1 and —O(CO)R2 denote identical or different non-aromatic C6-C18 monocarboxylic acid residues.

In a preferred embodiment of binuclear or polynuclear noble metal complexes of the type [LRh[O(CO)R1]]ₘ or [LIr[O(CO)R1]]ₘ, L denotes a compound acting as a diolefin ligand; m denotes 2, 3, 4, or 5, and preferably 2; and —O(CO) R1 denotes a non-aromatic C6-C18-monocarboxylic acid residue.

Examples of diolefins or compounds of the L type that are capable of acting as a diolefin ligand include hydrocarbons such as COD (1,5-cyclooctadiene), NBD (norbornadiene), COT (cyclooctatetraene), and 1,5-hexadiene—in particular, COD and NBD. Preferably, these are pure hydrocarbons; however, the presence of heteroatoms is also possible—for example, in the form of functional groups.

X can be bromide, chloride, iodide, or —O(CO)R2, and preferably chloride or —O(CO)R2— in particular, —O(CO)R2.

The non-aromatic monocarboxylic acid residues —O(CO)R1 and —O(CO) R2 each denote identical or different non-aromatic C6-C18 monocarboxylic acid residues. The term, “non-aromatic,” as used in this context includes purely aromatic monocarboxylic acid residues, but does not include araliphatic monocarboxylic acid residues whose carboxyl function(s) is/are bonded to an aliphatic carbon. Preferably, —O(CO)R1 and —O(CO)R2 denote identical, non-aromatic C6-C18 monocarboxylic acid residues. Preferred non-aromatic C6-C18 monocarboxylic acid residues are monocarboxylic acid residues having 8 to 18 carbon atoms, i.e., non-aromatic C8-C18 monocarboxylic acid residues.

Examples of non-aromatic C6-C18 or the preferred C8-C18 monocarboxylic acids having —O(CO)R1 or —O(CO)R2 radicals are isomeric hexanoic acids, including n-hexanoic acid; isomeric heptanoic acids, including n-heptanoic acid; isomeric octanoic acids, including n-octanoic acid and 2-ethylhexanoic acid; isomeric nonanoic acids, including n-nonanoic acid; and isomeric decanoic acids including n-decanoic acid, to name only a few examples. Included are not only linear representatives, but also those with branches and/or cyclic structures—for example, 2-ethylhexanoic acid, cyclohexanecarboxylic acid, and neodecanoic acid. The residues R1 and R2 in each case bonded to a carboxyl group comprise 5 to 17 or 7 to 17 carbon atoms.

Preferred examples of platinum complexes include [(COD) Pt[O(CO)R1]2]ₙ and [(NBD) Pt[O(CO)R1]2]ₙ, wherein n is 1 or 2 and in particular equal to 1, and wherein R1 is a non-aromatic C5-C17 hydrocarbon residue.

Preferred examples of palladium complexes include [(COD) Pd[O(CO) R1]2]ₙ and [(NBD)Pd[O(CO)R1]2]ₙ, wherein n is 1 or 2 and in particular equal to 1, and wherein R1 is a non-aromatic C5-C17 hydrocarbon residue.

Preferred examples of rhodium complexes include [(COD) Rh[O(CO) R1]]ₘ and [(NBD)Rh[O(CO)R1]]ₘ, wherein m is 2, and wherein R1 is a non-aromatic C5-C17 hydrocarbon residue.

Preferred examples of iridium complexes include [(COD)Ir[O(CO)R1]]ₘ and [(NBD)Ir[O(CO)R1]]ₘ, wherein m is 2, and wherein R1 is a non-aromatic C5-C17 hydrocarbon residue.

The at least one organic noble metal complex is preferably readily soluble in both polar and non-polar solvents. In one embodiment, the at least one organic noble metal complex is readily soluble in solvents of intermediate polarity. Solvents of intermediate polarity include, for example, short-chain ethers and alcohols, as well as glycol ethers.

In one embodiment, the solubility of the at least one organic noble metal complex in ethanol at 25° C. and 1,013 hPa is at least 1%, and preferably at least 2%, 3%, 4%, 5%, or at least 10%, by mass.

In one embodiment, the solubility of the at least one organic noble metal complex in toluene at 25° C. and 1,013 hPa is at least 1%, and preferably at least 2%, 3%, 4%, 5%, or at least 10%, by mass.

In one embodiment, the solubility of the at least one organic noble metal complex in a solvent mixture comprising eight parts of ethanol and two parts of water is, at 25° C. and 1,013 hPa, at least 1%, and preferably at least 2%, 3%, 4%, 5%, or at least 10%, by mass.

In some embodiments, the at least one organic noble metal complex is virtually unlimited in the organic solvent or in any of the solvents mentioned herein. This means that the at least one organic noble metal complex and the solvent are miscible with one another in any ratio.

The solubility of the at least one organic noble metal complex in the solvent can be determined, for example, by gradually adding the solvent in a small amount to a defined amount of the at least one organic noble metal complex at 25° C. and 1,013 hPa until all of the solid is dissolved.

The at least one organic noble metal complex can be prepared simply by ligand exchange, and in particular without using carboxylic acid salts of silver. The production process comprises mixing or suspending or emulsifying a two-phase system. The one phase comprises a starting material of the type [LPtX₂]ₙ, or LPdX₂, [LRhX]₂, or [LIrX]₂, in each case with X selected from bromide, chloride, and iodide, and preferably chloride, either as such or preferably in the form of an at least substantially water-immiscible organic solution of such a reactant. Examples of organic solvents that are suitable and at least substantially water-immiscible for preparing such an organic solution comprise, in addition to aromatics and chlorinated hydrocarbons, such as toluene, xylene, di-, tri-, and tetrachloromethane, oxygen-containing solvents—for example, corresponding water-immiscible ketones, esters, and ethers. The other phase, on the other hand, comprises an aqueous solution of alkali salt (in particular, sodium or potassium salt) and/or magnesium salt of a C6-C18 monocarboxylic acid of the R1COOH type and, optionally, additionally of the R2COOH type. The choice of the type of monocarboxylic acid salt(s) depends upon the type of noble metal complex to be produced or the combination of noble metal complexes to be produced. The two phases are mixed intensively to form a suspension or emulsion—for example, by shaking and/or stirring. For the purpose of maintaining the suspension or emulsion state, the mixing is carried out, for example, for a period of 0.5 to 24 hours—for example, at a temperature in the range of 20 to 50° C. In this case, ligand exchange takes place, wherein the noble metal complex(es) formed in the organic phase are dissolved, while the alkali X salt or MgX₂ salt likewise formed is dissolved in the aqueous phase. After the suspension or emulsification, organic and aqueous phases are separated from one another. The noble metal complex(es) formed can be obtained from the organic phase and, optionally, subsequently purified by means of conventional methods.

For example, to give just one specific example, (COD)Pt[O(CO)CH(C₂H₅)C₄H₉]₂ can be prepared by co-emulsifying a solution of (COD)PtCl₂ in dichloromethane with an aqueous solution of sodium-2-ethylhexanoate. After completion of the emulsification, the sodium chloride solution formed by ligand exchange can be separated from the dichloromethane phase, and (COD)Pt[O(CO)CH(C₂H₅)C₄H₉]₂ can be isolated from the latter and optionally purified by means of customary purification processes. Analogously, the platinum complex (COD)Pt[O(CO)CH(C₂H₅)C₄H₉]Cl can also be prepared with, for example, an appropriately selected stoichiometry.

An important property in addition to the aforementioned solubility in conventional organic solvents is the comparatively low decomposition temperature of the at least one organic noble metal complex of component B—for example, already from 150° C. to 250° C., and often not higher than 200° C. This combination of properties makes it possible to use such noble metal complexes as constituent B of the composition for modifying graphitized carbon materials.

In one embodiment, said at least one organic noble metal complex can be present in the composition in an individualized form, but also in a combined form, i.e., alone or else as a mixture of several different species. Thus, platinum complexes can be present in the composition in an individualized or combined form, i.e., alone or as a mixture of several different species in each case of the type [LPt[O(CO)R1]X]ₙ. Palladium complexes can also be present in the composition in an individualized or combined form, i.e., alone or as a mixture of several different species in each case of the type [LPd[O(CO) R1]X]ₙ. Rhodium complexes can also be present in the composition in an individualized or combined form, i.e., alone or as a mixture of several different species in each case of the type [LRh[O(CO)R1]]ₘ. Similarly, iridium complexes can also be present in the composition in an individualized or combined form, i.e., alone or as a mixture of several different species, in each case of the type [LIr[O(CO)R1]]ₘ. In other words, constituent (B) can comprise compounds of the [LPt[O(CO)R1]X]ₙ, [LPd[O(CO)R1]X]ₙ, [LRh[O(CO)R1]]ₘ, and/or [LIr[O(CO)R1]]ₘ type. Accordingly, constituent B can comprise compounds of only one of the two, three, or all four of the types disclosed herein, wherein the respective type can be represented in only one individual form (individualized) or in more than one individual form (associated). The term, “individual form,” as used in this context means the formula type with a specific index n or m; for example, [LRh[O(CO)R1]]₂ is the individual form of the general type [LRh[O(CO)R1]]ₘ, where m=2.

In one embodiment, the composition can comprise the following constituents:
(A) 30 to 90 wt % (% by weight) of at least one organic solvent,
(B) 10 to 70 wt % of at least one organic noble metal complex dissolved in the solvent.

Preferred compositions can be prepared by simply mixing constituents A and B. A person skilled in the art will select the quantitative ratio of the constituents adapted to the respective intended use and/or the impregnation method used in that case.

As a result of the impregnation step, an impregnated (i.e., loaded with the at least one organic noble metal complex) support material is obtained. In this case, impregnation is understood to mean the adsorption of the at least one organic noble metal complex on the surface of the support material. In the case of a porous carbon material, this is in particular an inner surface, i.e., a surface within the pores.

Various impregnation methods are known to a person skilled in the art, such as capillary-controlled (incipient wetness) or diffusion-controlled impregnation.

Preferably, the composition and graphitized carbon material are stirred, rolled, kneaded, or otherwise mixed during the impregnation step.

Preferably, the support material is dispersed in the composition during the impregnation step.

During the impregnation step, the temperature of the composition is, for example, 20° C. to 95° C., more preferably 40° C. to 90° C. or 60° C. to 80° C., and in particular 50° C. to 70° C.

The duration of the impregnation step is selected such that the at least one organic noble metal complex can be deposited on the support material in a sufficient quantity. A suitable duration can be determined by a person skilled in the art on the basis of routine experiments.

During the impregnation step, the support material is present, for example, in an amount of 1 wt % to 70 wt %, more preferably 3 wt % to 60 wt %, and most preferably 5 wt % to 50 wt %, relative to the total weight of the composition and support material.

During the impregnation step, the support material and the noble metal derived from the at least one organic noble metal complex are present in a weight ratio of at least 1:1, and more preferably in a weight ratio of at least 2:1. In a ratio of at least 1:1, this means that at least 50 wt % of the weight consisting of the weight of the support material and the weight of the noble metal derived from the at least one organic noble metal complex is made up of the weight of the support material.

Optionally, before the thermal treatment is carried out in step (c), the impregnated support material can first be dried and partially or completely freed of the organic solvent.

It may also be preferable to filter out and dry the impregnated support material.

For example, the impregnated support material is dried at a temperature below 250° C., more preferably below 200° C., and even more preferably below 150° C.

In particular, the drying can take place under reduced pressure, and preferably at a pressure of less than 100 mbar.

The drying preferably takes place for a period of 30 minutes to 180 minutes, and preferably for a period of 60 minutes to 120 minutes.

The drying preferably takes place in the absence of oxygen—for example, in a vacuum or under an inert gas.

In process step (c), the impregnated, graphitized carbon material is thermally treated.

In one embodiment, the thermal treatment of the impregnated, graphitized carbon material results in decomposition of the at least one organic noble metal complex.

Preferably, the thermal treatment results in residue-free decomposition of the at least one organic noble metal complex. In this case, residue-free decomposition means that the organic constituents of the complex are decomposed, i.e., they have completely decomposed into volatile components.

The thermal treatment can be carried out above the decomposition temperature of the at least one organic noble metal complex. In general, a temperature slightly above the decomposition temperature in question is selected.

The thermal treatment can take place in particular in a closed vessel.

The thermal treatment is preferably carried out in the absence of oxygen. In particular, the thermal treatment can be carried out in an inert gas atmosphere or in a vacuum.

In one embodiment, the thermal treatment results in evaporation of the solvent. In one embodiment, the solvent is evaporated by the thermal treatment, and the at least one organic noble metal complex is completely decomposed. In one embodiment, after the thermal treatment of the impregnated support material, no further constituent of the composition remains on the support material except for the at least one noble metal.

The thermal treatment can take place at a temperature of less than 1,000° C., 900° C., 800° C., 700° C., 600° C., 500° C., 400° C., 300° C., 250° C., or less than 200° C. Preferably, the impregnated support material is thermally treated at a temperature of more than 220° C., and particularly preferably at a temperature higher than 250° C.

In a preferred embodiment, the impregnated support material is thermally treated at a temperature of 150° C. to 250° C.

In general, the thermal treatment does not take longer than 90 minutes. The thermal treatment can take place for a period of 1 minute to 90 minutes, and preferably for 5 minutes to 60 minutes.

When several different noble metal complexes are present, a person skilled in the art will select the thermal treatment above the decomposition temperature of the noble metal complex having the highest decomposition temperature. In general, this is done, for example, by a brief treatment carried out at a temperature above the decomposition temperature, e.g., for a period of 1 minute to 60 minutes at a temperature in the range of 200° C. to 250° C. or from 250° C. to 300° C. or higher—for example, up to 1,000° C.

When working with compositions based upon platinum complexes of the type [LPt[O(CO) R1]X]ₙ or palladium complexes of the type [LPd[O(CO)R1]X]ₙ, substantially metallic noble metal is formed during thermal decomposition even in the presence of air as the surrounding atmosphere; in the case of thermal decomposition when working with compositions based upon rhodium complexes of the type [LRh[O(CO)R1]]ₙ or based upon iridium complexes of the type [LIr[O(CO)R1]]ₙ, in contrast, in the presence of oxygen, in addition to the metallic noble metal, the corresponding noble metal oxide or even primarily noble metal oxide can be formed.

In this respect, a person skilled in the art will understand the term, “noble metal-modified,” as used herein as substantially comprising or even exclusively comprising metallic platinum or palladium, as comprising rhodium and/or rhodium oxide, or as comprising iridium and/or iridium oxide.

If the composition comprises a combination of two or more of the noble metal complex types disclosed herein as constituent B, the support material can also be modified with more than one noble metal. The quantitative ratios of platinum, palladium, rhodium, and iridium can be adjusted very easily in the composition via the respective proportions of the noble metal complexes.

The noble metal-modified, graphitized carbon material produced by means of the process according to the invention contains the noble metal, for example, in an amount of 5 wt % to 70 wt %, and more preferably 15 wt % to 60 wt % or 25 wt % to 50 wt %, in each case, relative to the total weight of the noble metal-modified, graphitized carbon material.

In a preferred embodiment, the noble metal is present in particulate form on the support material after thermal treatment.

The average particle size of the noble metal-containing particles on the graphitized carbon material is preferably in the range of 1 to 100 nm, more preferably 2-50 nm, and particularly preferably in the range of 2.2-5.5 nm, measured by means of X-ray diffractometry (XRD) and determination at the (111) reflex.

The noble metal particles preferably have an average diameter of at least 0.5 nm, and more preferably at least 1 nm.

The noble metal particles preferably have a mean diameter of not more than 30 nm, more preferably not more than 20 nm, and particularly preferably not more than 10 nm.

The noble metal particles preferably have a mean diameter in the range of 1.0-5.0 nm, and more preferably in the range of 1.5-3.5 nm.

The noble metal particles preferably have an electrochemical surface area (ECSA) of 20 to 200 m²/g, and preferably 25 to 150 m²/g.

In a preferred embodiment, the noble metal-modified, graphitized carbon material is subjected to a washing step after the thermal treatment.

Methods for washing a particulate material are generally known to a person skilled in the art. Washing of the material is preferably carried out by dispersion in a solvent, separation of the solid constituents, and subsequent drying.

This washing step can be repeated if necessary. Preferably, such multiple washing steps are performed with different solvents.

In a preferred embodiment, the noble metal-modified, graphitized carbon material is subjected to a drying step after the thermal treatment.

In a further embodiment, after the optional washing step, the noble metal-modified, graphitized carbon material is subjected to a drying step.

The noble metal-modified, graphitized carbon material is dried, for example, at a temperature below 250° C., more preferably below 200° C., and even more preferably below 150° C.

In particular, the drying can take place under reduced pressure, and preferably at a pressure of less than 100 mbar.

The drying preferably takes place over a period of 30 minutes to 180 minutes, and preferably over a period of 60 minutes to 120 minutes.

A further subject matter of the present invention are noble metal-modified, graphitized carbon materials that can be used as supported catalysts obtainable by one of the processes described above. For preferred embodiments, reference is made to the above statements.

The supported catalysts produced according to the invention in the form of the noble metal-modified, graphitized carbon materials are particularly suitable for use in a PEM fuel cell, for example, both as anode catalysts and as cathode catalysts. The materials according to the invention are preferably used as cathode catalysts in PEM fuel cells.

When using supported catalysts according to the invention as an electrode in a PEM fuel cell, only water is ideally produced when catalyzing the oxygen reduction reaction, but not corrosive hydrogen peroxide (H₂O₂). The formation of H₂O₂ is effectively suppressed by the use of catalyst metal from the platinum group.

The present invention likewise provides an electrochemical cell containing a supported catalyst in the form of noble metal-modified, graphitized carbon materials according to the invention. For preferred embodiments, reference is also here made to the above statements.

The electrochemical cell is preferably a polymer electrolyte (PEM) fuel cell or a polymer electrolyte (PEM) electrolysis cell (for the electrolysis of water). The components required for the construction of a PEM electrolytic cell are known to a person skilled in the art. For example, the polymer electrolyte membrane (“PEM”) contains a polymer composed of monomers containing sulfonic acid groups.

For the production of electrodes, catalyst-coated membranes (CCM's) and membrane-electrode assemblies (MEA's) for PEM fuel cells, the supported catalysts according to the invention are processed into inks or pastes—specifically, using suitable solvents and, optionally, with the addition of ionomer materials. The supported catalyst inks are deposited on gas diffusion layers (GDL's), current collectors, ionomer membranes, preformed PTFE films, release papers or separator plates, and the like, wherein processes such as spraying, printing, blade coating, or other coating processes can be used. Corresponding processes are known to a person skilled in the art.

The present invention further relates to the use of the above-described supported catalyst for an electrochemical reaction.

This electrochemical reaction is, for example, the electrochemical reduction of oxygen (“oxygen reduction reaction,” ORR), the electrochemical oxidation of hydrogen (“hydrogen oxidation reaction,” HOR), the electrochemical formation of oxygen from water (“oxygen evolution reaction,” OER), or the electrochemical formation of hydrogen from water (“hydrogen evolution reaction,” HER).

The measurement methods used in the present invention are specified below. If no test method is specified, the appropriate ISO method, as valid on the filing date of the present application, was used to determine the parameter in question. If no specific measurement conditions are indicated, the measurement was carried out at room temperature (298.15 K) and standard pressure (100 kPa).

Powder Diffractometry

The degree of graphitization and the crystallite sizes Lₐ and L_{c} were determined by means of powder diffractometry.

Powder diffractometry was measured on a Stadi P diffractometer (STOE&Cie) in powder transmission geometry. A focusing Ge-111 monochromator provides monochromatic copper Kₐₗₚₕₐ₁ X-ray radiation at λ=1.54060 Å (generator parameters: 40 kV, 30 mA). Some mg sample materials were finely comminuted in an agate mortar, fixed between cellophane films with white glue, and placed in the STOE transmission sample holder. The STOE IPPSD detector was used. The samples were rotated in the transmission sample holder in the plane perpendicular to the X-ray beam at 50-150 rpm. The STOE WinXPOW software was used for sample collection. Measurements were made in a 2theta range of 8º to 84º; the recording time was 8,800 seconds. The 2theta step size is 0.015°.

Degree of Graphitization

The degree of graphitization g (in %) is determined by means of the following formula (1):

g=[(344 pm−d₀₀₂)/(344 pm−335.4 pm)]×100 (1)

where d₀₀₂ is the graphite basal plane spacing, which is determined by the known Bragg equation on the basis of the diffraction line of the (002) plane in the powder diffractogram of the graphitized carbon material.

The Bragg equation known to a person skilled in the art is as follows:

d=(n*λ)/(2*sinΘ)
where
λ is the X-ray wavelength,
n is the order of diffraction, and
Θ is the Bragg angle.

Determination of the crystallite sizes Lₐ and L_{c}

The crystallite sizes Lₐ and L_{c} were determined by fitting the full width at half maximum (FWHM) of the 100 (Lₐ, 2theta=42.223° and 002 (L_{c}, 2theta=26.382° reflexes of the hexagonal graphite structure via a peak fit. For this purpose, the STOE crystal analysis software was used. This software uses the Scherrer method or Scherrer equation known to a person skilled in the art. An LaB₆ sample was used to determine the instrumental broadening, which was subtracted from the fitted FWHM value before the calculation.

The Scherrer equation known to a person skilled in the art is as follows:

L=(K*λ)/((β−βᵢₙₛₜ)*cosΘ)
where
L is the average crystallite size,
K is a form factor,
λ is the X-ray wavelength,
β is the full width at half maximum (“FWHM”) of the reflex,
βᵢₙₛₜ is the full width at half maximum (“FWHM”) of the LaB₆ standard,
Θ is the Bragg angle.
A form factor of 0.9 is used in each case for Lₐ and L_{c}.

BET Specific Surface Area

The BET specific surface area was determined with nitrogen as an adsorbate at 77 K according to the BET theory (multipoint method, ISO 9277:2010).

Pore Volume and Pore Diameter Distribution

The pore volume and pore diameter distribution were determined by mercury porosimetry according to ISO 15901-1:2016.

Particle Size Distribution (d₅₀, d₉₀)

The particle sizes were determined by means of laser diffraction according to ISO standard 13320 with a Mastersizer 3000 (Malvern) equipped with an He-Ne Laser (wavelength: 632.8 nm, maximum energy 4 mW), a blue LED (wavelength 470 nm, maximum energy 10 mW), and a wet dispersion unit (Hydro MV). The measurement medium used was a mixture of 50 vol % isopropanol and 50 vol % de-ionized water. The volume weighted values for d₅₀ and d₉₀ were determined by means of the Malvern Mastersizer 3000 software 3.30, assuming a form factor of 1. Fraunhofer theory was used to determine particles having a size >10 μm; Mie theory was used for particles <10 μm.

Thermogravimetric Analysis of Noble Metal Content

The noble metal content was determined using a thermobalance (TG209 Libra from Netzsch). Assuming that the material consists only of a carbon support and a noble metal, the residual mass was determined for this purpose after treatment at 900° C. in air.

TEM Images

The distribution of the noble metal particles on the support material was examined by means of TEM (transmission electron microscopy).

A few μg of the material to be examined were suspended in ethanol. A drop of the suspension was then pipetted onto a Cu platelet (Plano, 200 mesh) coated with carbon aperture film and dried. The measurements were carried out in an FEI Talos 20-200 transmission microscope at 200 kV.

Size of the Noble Metal Particles

The particle size distribution of the noble metal particles was determined by means of small-angle X-ray scattering. The X'Pert Pro “Bragg-Brentano” device is operated in transmission geometry, and the primary beam is provided with a mirror to generate a collimated beam. Catalyst material (10-20 mg) is applied between two Mylar films in a transmission sample carrier. A sample holder with the corresponding support material is required to determine the substrate. The source of radiation was a Cu X-ray tube with a standard excitation of 40 kV and 40 mA and with a wavelength of 0.1542 nm.

The scattering curves obtained after substrate stripping were evaluated by means of PANalytical EasySAXS software (ver. 2.0). Particle size distribution curves were calculated using algorithms implemented in this software. The distribution curve D_{V}(R) resulting from this determination represents the volume-weighted particle size distribution (distribution according to particle volume). The average and most frequent particle size can be determined on the basis of the particle size distribution of the noble metal particles.

The invention is explained in more detail with reference to the following examples.

### Example 1 (Modification of a Carbon with Platinum According to the Invention)

A solution of 65 mmol of (COD) PtCl₂ was stirred in 100 mL of dichloromethane, and a solution of 260 mmol of sodium-2-neodecanoate was added to 500 ml of water. The two-phase mixture was emulsified at 20° C. for 24 h by vigorous stirring. The dichloromethane phase turned yellow. The dichloromethane phase was separated, and the solvent was distilled off. The viscous yellow residue was taken up in 150 mL of petroleum spirit (40-60), and the solution was dried with magnesium sulfate and filtered. The petroleum spirit was then completely distilled off. A viscous yellow residue of (COD) Pt[O(CO)(CH₂)₅C(CH₃)₃]₂ remained.

10 g of the yellow residue was dissolved in 20 g of a solvent mixture (50 wt % ethanol, 50 wt % propylene glycol monopropyl ether).

10 g of carbon (Heraeus Porocarb®; BET: 68 m²/g; degree of graphitization: 73%) was mixed with 100 mL of the solution containing 10 wt % platinum and vigorously stirred and homogenized for 30 min. The homogeneous mixture was treated at 250° C. in the first batch of a distillation apparatus under reduced pressure (0.1 mbar) over a period of 60 minutes. The solvent and the decomposition products were collected in the first batch and discarded. The product was cooled in the absence of oxygen and under an N₂ atmosphere.

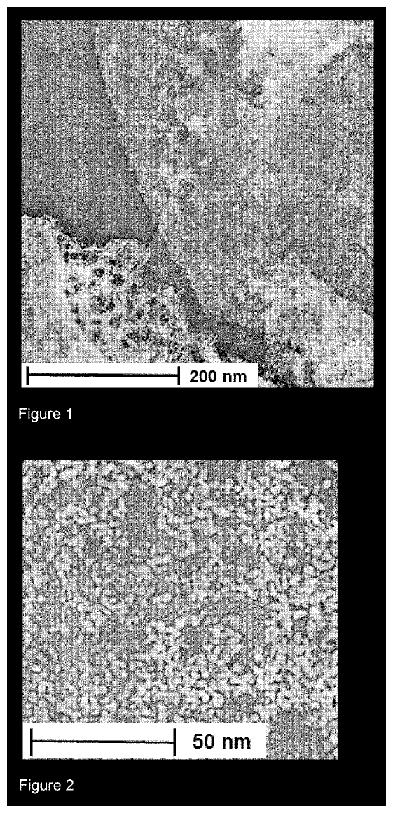

The proportion by weight of the platinum particles was 40%, relative to the total weight of carbon and metal. The particle size distribution of the platinum particles was determined by means of small-angle X-ray scattering. The average particle diameter was determined to be 1.6 nm, with the most common particle diameter being 1.8 nm. TEM images were taken of the platinum-modified carbon at various magnifications. FIG. 1 illustrates a very homogeneous distribution with a high degree of dispersion of the metallic platinum particles. FIG. 2 shows a representation of an image at a high magnification, which demonstrates the narrow size distribution of the platinum particles, which can also be deduced from the data of the particle size determination.

### Comparative Example 1 (Modification of a Carbon with Platinum)

The carbon from Example 1 was slurried with 100 ml of water, placed in a jacketed reactor, and filled to 2 L with water. The suspension was heated to 70° C. while stirring. After a holding time of 1 h, 30 g of a nitric acid Pt nitrate solution (10 wt % Pt) was added and then held for 1 h with constant mixing and temperature. Subsequently, the pH was adjusted to 1.5 by adding Na₂CO₃. Formic acid was then added in stoichiometric excess. After stirring at 70° C. for 8 h, the solid was filtered off from the aqueous medium, washed with water, and dried at 110° C. under a nitrogen atmosphere.

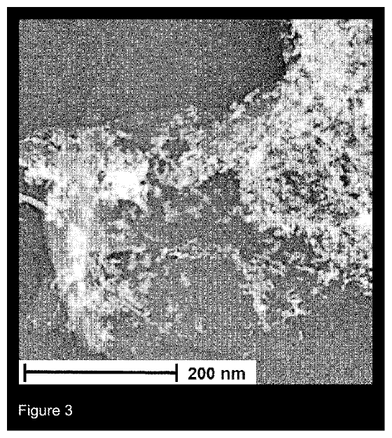

The proportion by weight of the platinum particles was 30%, relative to the total weight of carbon and metal. The representative TEM image in FIG. 3 shows a lower homogeneity of the metal particle distribution and a higher degree of clustering compared to the modified carbon according to the invention.

### Example 2 (Modification of a Carbon with Palladium According to the Invention)

A solution of 35 mmol of (COD)PdCl₂ was stirred in 200 mL of dichloromethane, and a solution of 140 mmol of sodium-2-ethyl hexanoate was added to 150 ml of water. The two-phase mixture was emulsified at 20° C. for 24 h by vigorous stirring. The dichloromethane phase turned yellow. The dichloromethane phase was separated, and the solvent was distilled off. The viscous yellow residue was taken up in petroleum spirit (40-60), and the solution was dried with magnesium sulfate and filtered. The petroleum spirit was then completely distilled off. A viscous yellow residue of (COD)Pd[O(CO)CH(C₂H₅)C₄H₉]₂ remained.

5 g of the yellow residue was dissolved in 5.6 g of a solvent mixture (50 wt % ethanol, 50 wt % propylene glycol monopropyl ether).

10 g of carbon was added to 100 mL of the 10 wt % palladium. The rest of the preparation was the same as described in Example 1.

1. A process for producing a noble metal-modified, graphitized carbon material, comprising the following process steps:
(a) providing a graphitized carbon material, wherein the graphitized carbon material has a degree of graphitization of at least 10%,
(b) impregnating the graphitized carbon material with a composition, wherein the composition comprises
(i) an organic solvent and
(ii) at least one organic noble metal complex dissolved in the organic solvent,
(c) thermal treatment of the impregnated, graphitized carbon material.

2. The process according to claim 1, wherein the noble metal is at least one metal of the platinum metal group.

3. The process according to claim 1, wherein the composition is a non-colloidal solution.

4. The process according to claim 1, wherein the composition comprises from 30 to 90 wt % organic solvent.

5. The process according to claim 1, wherein the composition comprises 10 to 70 wt % of the at least one organic noble metal complex.

6. The process according to claim 1, wherein the at least one organic noble metal complex is a noble metal complex having a diolefin ligand L and C6-C18 monocarboxylate ligands.

7. The process according to claim 1, wherein the at least one organic noble metal complex is a noble metal complex selected from the group consisting of noble metal complexes of the type [LPt[O(CO)R1]X]ₙ, [LPd[O(CO)R1]X]ₙ, [LRh[O(CO)R1]]ₘ, and [LIr[O(CO)R1]]ₘ, wherein X is selected from bromide, chloride, iodide, and —O(CO)R2, wherein —O(CO)R1 and —O(CO)R2 denote identical or different non-aromatic C6-C18 monocarboxylic acid residues, and wherein n is an integer ≥ 1, and m is an integer ≥ 2.

8. The process according to claim 6, wherein the diolefin ligand L is selected from the group consisting of COD (1,5-cyclooctadiene), NBD (norbornadiene), COT (cyclooctatetraene), and 1,5-hexadiene.

9. The process according to claim 1, wherein the composition comprises 2.5 to 25 wt % noble metal, relative to the total weight of the composition.

10. The process according to claim 1, wherein the support material is present in an amount of 1 to 70 wt % during the impregnation step.

11. The process according to claim 1, wherein the support material and the noble metal derived from the at least one organic noble metal complex are present in a weight ratio of at least 1:1.

12. The process according to claim 1, wherein the thermal treatment of the impregnated, graphitized carbon material results in decomposition of the at least one organic noble metal complex.

13. A noble metal-modified, graphitized carbon material obtainable by means of the process according to claim 1.

14. The noble metal-modified, graphitized carbon material according to claim 13, containing the noble metal in an amount of 5 to 70 wt %.

15. An electrochemical cell, containing a noble metal-modified, graphitized carbon material according to claim 13.
